(19) United States
(12) Patent Application Publication
(10) Pub. No.: US 2011/0210521 A1
(43) Pub. Date: Sep. 1, 2011

(54) Seal

(75) Inventors: Peter John Warren, Surrey (GB); Stephen Winterbottom, Surrey (GB)

(73) Assignee: JAMES WALKER & CO. LTD., Woking, Surrey (GB)

(21) Appl. No.: 13/054,131

(22) PCT Filed: Jul. 16, 2009
(86) PCT No.: PCT/GB2009/050874

§ 371 Date: Mar. 18, 2011

(30) Foreign Application Priority Data
Jul. 16, 2008 (GB) 0812998.3
May 5, 2009 (GB) 0907667.0

(51) Int. Cl. F16J 15/10

(52) U.S. Cl. 277/650; 264/171.1

(57) ABSTRACT

A seal is described which has good low temperature flexibility and includes a core (3) comprising an elastomer, and an outer layer (7) on the core comprising an elastomer. In some examples described, the Tg of the core is greater than the Tg of the outer layer. Seals described have high chemical resistance as well as good resistance to explosive decompression.

This invention relates to seals. Some examples of the invention relate to elastomeric seals having high resistance to explosive decompression. Some examples of the invention relate to elastomeric seals adapted for use at low temperatures.

Elastomeric seals are used in a wide range of applications and environments. Aspects of the invention relate particularly, but not exclusively, to seals for use in the oil and gas industries.

Some of the environments in which elastomeric seals are used provide particular challenges in view of chemical and physical factors of the environments. Examples of such challenging environments can be found in the oil and gas industries. Indeed, there is a trend for the oil and gas to be extracted from ever more extreme environments. There is a demand for elastomeric seals to function at low temperatures, for example as low as minus 46 degrees C., or even lower. Elastomers with the required chemical resistance are generally are less responsive and thus may be unsuitable for performing a sealing function at such temperatures.

Requirements of chemical resistance can also severely restrict the choice of polymers in many applications. For example, resistance to steam is often a requirement for the seal, for example in situations where steam is used in the extraction of oil. There may also be a requirement for the seal to be resistant to the presence of amines and/or other chemicals, for example methanol and/or aliphatic and aromatic hydrocarbons, drilling muds and hydrogen sulphide.

Currently, it is believed that none of the currently available polymers which have the necessary chemical resistance for certain contact media will provide adequate sealing performance at low temperatures as well as the desired mechanical properties, for example below minus 10 degrees C. While some polymers such as so-called ‘low temperature’ fluoroelastomers (FKMs) (for example Viton GLT or GFLT) can give acceptable performance in the presence of hydrocarbons and some fluids encountered in the oil well environment, problems can occur when such materials come into contact with other chemicals, for example ‘sour gas’ (containing H2S), or amines which have been found to attack known FKMs. Other known polymers such as AFLAS (RTM—Asahi Glass) which give better performance in the presence of such chemicals, have insufficient sealing performance at low temperatures. For example, AFLAS® has a TR10 of about +2C. It would be desirable for low temperature performance (for example at −10 degrees C. and below), to be available for a material having a chemical resistance to a broad range of chemicals.

In an attempt to provide seals for use in such environments, valve manufacturers are using spring energised PTFE lip seals, but these are costly, more difficult to fit, and generally require housings with a higher standard of finish than those for elastomeric seals Alternatively or in addition, local heating and/or heat insulation is used in an attempt to avoid very low local temperature at the seal.

An additional or alternative requirement for some seals, for example those used in the oil and gas extraction industries is resistance to rapid gas decompression, or RGD also known as Explosive Decompression or ED. ED can lead to damage of a seal, including structural failure in the form of blistering, internal cracking and splits which can be caused when the fluid pressure to which the seal is exposed is rapidly reduced.

Examples of the present invention seek to overcome or mitigate one or more of these and/or other problems.

In some applications and environments, seals will advantageously seek to overcome or mitigate several or all of the above-mentioned problems. In other applications or environments, only some or one of the problems will need to be mitigated or overcome. According to an aspect of the invention there is provided a seal comprising an inner core including core material, and an outer layer on the core comprising layer material wherein: the core material includes an elastomer; the layer material includes a chemically resistant material; the seal being resistant to rapid gas decompression (RGD).

By providing an elastomeric core material and a chemically resistant outer material, it is possible to provide a seal having desirable chemical resistance and desirable resistance to RGD.

Thus an example of the invention may comprise a core having good RGD/ED resistance and a chemically resistant outer layer. In some cases, the resulting product need not have good low temperature performance. There are many applications for RGD resistant seals where low temperature performance is not an important issue. In accordance with the invention, ED/RGD performance may be provided in combination with chemical resistance for applications where low temperature flexibility is not required. Preferably the seal is flexible at a temperature less than minus 10 degrees C. The low temperature flexibility of the seal may be provided by the core, the outer layer, or both, and/or may be provided by another component or layer. The seal may comprise three or more portions, for example one portion resistant to RGD, a second portion being flexible at a low temperature, and a third being chemically resistant. It will be appreciated that the chemically resistant layer will be provided at an exterior surface of the seal which is generally the surface in contact with the chemical environment. It will be seen that any portion of the seal may provide one or more of the required properties of RGD resistance, low temperature flexibility and/or chemical resistance.

In a broad aspect of the invention, there is provided a seal comprising a first material having RGD resistance and a second material having chemical resistance. These materials may be provided in a layer structure, or in any other arrangement. They may be mixed or combined to provide a composite material forming the seal or a part of the seal. Optionally one or more of the materials may have low temperature flexibility, and/or a third material having low temperature flexibility may be provided.

Preferred features of the core material are now described. Preferably, in addition or alternatively, the seal itself has one or more of these features. In addition or alternatively the outer layer has one or more of these features.

Where one portion of the seal has the desirable low temperature flexibility, other portions of the seal might not have the desirable low temperature flexibility. For example a low temperature flexible material could be provided on the outside of an RGD resistant core having a significantly higher Tg than that of the outer material.

Preferably the core material is flexible at a temperature less than minus 10 degrees C. In some applications, the core material may have a lower temperature flexibility limit at a higher temperature. For example, AFLAS® having the required flexibility at a temperature to about +2C at atmospheric pressure could be used as the core material in some applications.

By providing an inner core having the required low temperature flexibility and an outer layer which is chemically resistant, the resulting seal can be suitable for use in harsh chemical environments at low temperatures. For example, the core material might not have the required chemical resistance itself for use in the relevant environment, and the layer material might not have the required low temperature flexibility.

Preferably the core material and the outer layer material are different from each other. Preferably the term core should be taken to refer to a portion of the seal being within the outer layer. In preferred examples, the core is completely covered by the layer on any surface of the seal which is exposed in use to the operating environment. Not all the core need be covered by the outer layer. In some examples, the core will comprise a centre portion of the seal. However, in other arrangements a further component or portion may be provided within the core so that in those examples the inner core comprises a layer beneath the outer layer. The core may comprise more than one portion of which the elastomer material may be an inner or outer portion.

Where reference is made to the core material, or other material being flexible at a particular temperature, preferably that reference is to the material being sufficiently flexible so that it may operate as a seal at the particular temperature.

In a broad aspect of the invention discussed further below, the lowest temperature at which the core material is flexible may, in some examples, be higher than the lowest temperature at which the layer material is flexible. In other arrangements, the reverse is preferred.

Preferably the core of the seal is flexible at less than minus 20 degrees C., preferably less than minus 30, 40, 46, 50, 60, 75 or even less than minus 90 degrees C.

The flexibility of the material at the relevant temperature can be determined directly, for example by making a seal comprising the relevant material and observing the performance of the seal at the relevant temperature.

Other tests or information could be used. For example, a property of the material at the relevant temperature could be determined to identify whether the material is flexible.

Preferably the Tg of the core material is below minus 10 degrees C. Preferably Tg is less than minus 20 degrees C., preferably less than minus 30 degrees C., preferably less than minus 40 degrees C. The Tg of the core material may be below minus 46 degrees C. Preferably the Tg of the core material is below minus 60, 70, 80 degrees C. or even lower. The Tg of the core material may be below minus 60 degrees C., preferably below minus 90 degrees C.

The Tg of the material could be determined using any appropriate method. Preferably where reference is made to the Tg of the material, preferably the Tg value refers to that at the pressure of the environment in which the material is to be used. Conveniently, as an alternative, the Tg may be understood to refer to the Tg at atmospheric pressure, if appropriate. As an example, it is thought that for every 50 bar pressure, the Tg of a material will rise by about 1 degree C.

Alternatively or in addition, a temperature retraction test could be carried out on the material to determine whether or not it is suitably flexible at the relevant temperature. Preferably the TR10 of the core material is less than minus 10, 20, 30 degrees C. Preferably the TR10 of the core material is less than minus 46 degrees C., preferably less than minus 60 or minus 90 degrees C.

An example of a temperature retraction test includes elongating a test specimen and freezing it in the elongated position. The specimen is then allowed to retract freely while the temperature is slowly raised at a uniform rate. The percentage retraction can be calculated at any temperature from the data obtained.

In practice, it is seen that the temperature corresponding to 10 per cent retraction (TR10) roughly correlates to the temperature limit for useful flexibility of the material. Further details of example tests may be found in for example ASTM D1329. In some applications, seals may be able to function at lower temperatures in static applications. The core material may have one or more of the features indicated above related to the low temperature flexibility. It should be understood that a particular material need not include all of those features.

In preferred arrangements, preferably the material of the seal itself and/or the outer layer has properties within the ranges indicated above for the core elastomer.

Preferably the hardness of the core elastomer and/or the seal is about 80 to 90 IRHD (International Rubber Hardness Degrees)

A broad aspect of the invention provides a seal comprising an inner core including core material, and an outer layer over the core comprising layer material wherein: the core material includes an elastomer, the seal is flexible at a temperature less than minus 10 degrees C. and the layer material includes a chemically resistant material.

The low-temperature flexibility of the seal may be provided by the core, the outer layer and/or other portion of the seal.

Features described in respect of one aspect of the invention are preferably applicable to other aspects of the invention, as appropriate.

Preferably the seal is also resistant to rapid gas decompression or explosive decompression.

RGD damage or ED damage comprises structural damage or failure caused when fluid pressure, to which the seal is exposed is rapidly reduced.

Without wishing to be tied to any particular explanation of RGD, it is generally thought to occur as a result of the permeation and diffusion of gases dissolved in the elastomer. With time, elastomeric components will become saturated with gases in the system. When pressure fluctuations occur, large pressure gradients can be created between the interior and the surface of the elastomeric component. This pressure differential may be balanced by the gas diffusing or permeating out of the elastomer. However, if the physical properties of the elastomeric compound cannot resist crack and blister growth during the permeation, then structural failure can occur.

RGD damage is a problem which is often encountered in the oil and gas industry, although it can be a problem in any application where there is a rapid drop in a fluid pressure, for example in paint guns and fire extinguishers to compressors and refrigerants systems.

Advantageously, the seal is such that it is resistant to RGD damage.

The resistance to RGD may be determined by testing the seal in the appropriate environment for the required application, and/or other tests may be used.

Preferably the seal meets the RGD acceptance criteria of the Norsok M710 test (Annex B. Preferably any damage to the seal as a result of the test has a rating of 3 or less, preferably 2 or less, preferably 1 or less.

Alternatively or in addition, the seal passes preferably the Explosive Decompression Test described below, or other applicable tests or test conditions for testing for resistance to RGD or ED.

Preferably the seal has the relevant RGD resistance at a temperature of less than minus 10, preferably less than minus 20, 30, 40, 50, 60, 75 or even minus 90 degrees C. Preferably the seal has the relevant RGD resistance in the presence of CO2 and/or or mixtures of methane (or other hydrocarbon) and CO2 dependant on the application for the seal. The latter is thought generally representative of well fluids. RGD tests may be carried out in the presence of those gases.

Other substances to which a seal may be exposed in oil and gas applications include amines which are used as corrosion inhibitors, drilling mud used as a lubricant and medium for removal of waste material, methanol is injected into some wells to assist with extraction. Seals may be exposed to these media, though not necessarily at high pressures. H2S is present in some well fluids, though is not generally currently used in ED/RGD tests for safety reasons, although could be used in the tests if the safety issues could be overcome. Presently, methane and CO2mixtures are thought to be acceptable for use in tests establishing ED/RGD properties.

Preferably the RGD test is carried out at an elevated temperature, for example 100 degrees C. In many cases, if a seal passes an RGD test carried out at 100 degrees C., it will be suitable for use at lower temperatures, for example minus 10 degrees C., minus 30 degrees C. or lower.

Preferably the seal has RGD resistance to changes in pressure of greater than 30 bar/hr, preferably greater than 40 bar/hr, preferably greater than 50 bar/hr.

While the seal itself is required to be resistant to RGD, preferably the core is resistant to RGD. The outer layer may be resistant to RGD. Alternatively or in addition a further portion or layer of the seal may be RGD resistant.

Preferably the core is RGD resistant according to one or more of the terms and descriptions herein in relation to the seal. Preferably the core itself passes one or more of the tests for RGD resistance described herein.

The core material may comprise silicone and/or a silicone-containing material.

It has been identified that silicone withstands explosive decompression relatively well. Without wishing to be bound by any particular theory, the applicants believe that the relatively high permeability of the silicone material is a factor in this. However, generally, silicone lacks the chemical resistance and mechanical properties which would allow for its widespread use in for oil and gas applications.

According to a further aspect of the invention, there is provided a seal comprising a core, the core including silicone and/or a silicone-containing material, and an outer layer on the core, the outer layer comprising a chemically resistant material, preferably wherein the seal is resistant to rapid gas decompression.

Preferably the core includes silicone and/or fluorosilicone. While fluorosilicone has a lower permeability than silicone, the permeability is still comparatively high. Silicone-based materials are considered to be particularly appropriate for such application due to their relatively high permeability. For example, gas transmission rates for silicone rubber has been measured at 1800 cc/m2/hr under 5 bar N2 at 20C. This can be compared to a transmission rate of about 50 cc/m2/hr under 5 bar N2 at 20C for FKM. It is noted that a pressure drop is sometimes seen when silicone seals are used in closed systems.

Silicone rubber also remains flexible at low temperatures. Silicone has an extremely low Tg and remains flexible at temperatures of minus 40 degrees C. and below. For comparison, however, the TR-10 of AFLAS (RTM—Asahi Glass) however, is between about minus 10 and plus 3 degrees C., depending on the type of AFLAS; and AFLAS has suitable flexibility for use at about 0 degrees C. and in some cases can provide adequate sealing even below that temperature. Other base resistant polymers, for example FKM materials are available from other manufacturers such as Solvay and DuPont. A grade of FKM available from Solvay (Solvay BR 9152) is operable at around −17 degrees C., though by comparison to AFLAS has poor amine resistance. Such fluorinated materials might be used in examples of the present invention as materials for the outer layer.

However, it is also thought that RGD resistance can be engineered in other ways. For example, elastomers having quite low levels of permeability compared with silicone can exhibit good RGD resistance. An example is very ‘tough’ elastomers. The inventors have identified that careful compounding of other elastomers, for example EPM, may also result in suitably RGD resistant materials. Thus even non silicone-based materials having a relatively low permeability might have suitable RGD resistance and therefore would be useful as a material for use in the seals according to the present invention.

A further aspect of the invention provides a seal comprising a core and a layer of material on the core, wherein the core includes an elastomeric material, the core further comprising a permeable material, the layer material including an elastomeric material. Preferably the material has good extrusion resistance. Preferably the material has a level of permeability sufficient to reduce the risk of interlayer blistering during use in the relevant conditions.

The permeable core is preferably gas permeable and therefore in some examples allows rapid gas release from this part of the seal cross section. This arrangement can reduce the stresses imparted to the material through RGD which might otherwise lead to damage of the material. An outer layer of the seal then includes an elastomer which preferably provides the mechanical and environmental resistance required for the relevant application of the seal.

A high strength outer layer for example could impart extrusion resistance to the material. Chemical resistance appropriate to the application of the seal will be desirable. However, in some applications chemical resistance may not be required.

The permeable core may be provided in all or a part of the seal. For example, permeable material may be provided at certain regions of the seal, for example those thought more at risk from RGD damage, for example relatively thicker sections. Different materials may be provided at different parts of the core.

The core material may include silicone material. For example the core may include silicone, or may include EPDM/Silicone, or other composition. The core may include silicone and/or fluorosilicone.

The gas transmission rate through the core material may be more than 200, preferably more than 500, 1000, 1500, 1800 cc/m2/hr or more under 5 bar N2 at 20C.

Preferably the core includes a silicone and/or a fluorosilicone material. Silicone-based materials are considered to be particularly appropriate for such application due to their relatively high permeability. For example, gas transmission rates for silicone rubber has been measured at 1800 cc/m2/hr under 5 bar N2 at 20C. This can be compared to a transmission rate of about 50 cc/m2/hr under 5 bar N2 at 20C for FKM. It is noted that a pressure drop is sometimes seen when silicone seals are used in closed systems. Preferably the gas transmission rate through the core material is more than 200, preferably more than 500, 1000, 1500, 1800 cc/m2/hr or more under 5 bar N2 at 20C. The core material may comprise an ethylene-propylene elastomer. For example, the core material may comprise EPM and/or EPDM.

The core material may comprise any other appropriate elastomer or combinations of elastomers. The material may comprise polybutadiene.

Materials other than silicone could be used as the core material, in particular if it has acceptable RGD resistance and low temperature flexibility. Preferably the core material has flexibility at 20 degrees C or lower, preferably −46 degrees C. or lower, even more preferably lower still. In some applications, preferably the core material has flexibility at minus 60 degrees C. (for example methyl vinyl silicone or fluorosilicone) or even minus 90 degrees C. (for example phenyl silicone).

Preferably the core material is an elastomeric material.

The core may comprise one material, or may comprise more than one material. The core may comprise a plurality of portions, for example layers, of different materials.

However, silicone and other RGD resistant elastomers may have relatively poor chemical resistance.

By providing the chemically resistant layer, this problem can be overcome in some examples.

Preferably, the material of the outer layer is resistant to one or more of:
i. steam
ii. amines
iii. hydrocarbons (aliphatic and aromatic)
iv. methanol
v. Drilling muds
vi. Hydrogen sulphide

Preferably the material of the outer layer is to be considered to be resistant to the substance if when the material is exposed to the relevant substance for 72 hours, the change in volume of the material is less than 15%, preferably less than 10% preferably less than 5%, more preferably less than 2% of its original volume before exposure.

Alternatively, or in addition, the material of the outer layer is to be considered to be resistant to the substance if when the material is exposed to the relevant substance for 72 hours, the change in physical properties of the material (for example hardness, modulus, tensile strength) is less than 30%, preferably less than 20%, preferably less than 10%, preferably less than 5% of its original value before exposure. In some arrangements, changes in hardness of 10IRHD or less are acceptable.

Alternatively or in addition, preferably the material of the outer layer is to be considered to be resistant to the substance if when the material is exposed to the relevant substance for 72 hours, the material does not show a tendency towards dissolution, blistering, cracking or other physical damage.

Preferably the outer layer material is such that any changes in volume under service conditions are within about +10% and −5%. Changes significantly greater than that would be expected to impair performance unacceptably.

Preferably the outer layer material comprises an elastomer.

A seal according to any preceding claim, wherein the outer layer comprises a fluorine-containing elastomeric material.

Fluorine-containing materials generally have good chemical resistance. However, other materials could be used, for example HNBR which has resistance to amines, up to about 5% concentration in other media, and aliphatic hydrocarbons and aromatic hydrocarbons up to about 6% concentration in other media, dependant upon ACN content.

The outer layer may comprise HNBR.

Different combinations of suitable cores and outer layers may be provided by the invention.

For example an independent aspect of the invention may provide a seal comprising a core including silicone and an outer layer including a fluorine-containing elastomeric material.

For example, an independent aspect of the invention may provide a seal comprising a core including EPM or EPDM and an outer layer of HNBR.

Other combinations are possible. For example the seal may comprise a fluorocarbon-containing core material, preferably flexible at low temperature (for example an elastomer based on VITON (RTM—Du Pont) GLT or GFLT), and for example a fluoroelastomer tetrapolymer outer, for example VITON® ETP. Such a seal may for example be operable at minus 30 degrees C. or lower.

Fluorine-containing elastomers, for example FKM or FFKM, generally have good chemical resistance, but some have relatively poor explosive decompression resistance and their usability at low temperature is also not appropriate in some cases. FKM materials can be compounded to give improved RGD resistance. Some special grades of FKM can also operate at low temperatures (typically −40C, e.g. VPL 85540 from Solvay). These known special grades do not however have suitable chemical resistance for some applications. For example some of the special grades do not have good resistance to steam and bases such as amines. For example, known grades of AFLAS™ (a tetrafluoroethylene/propylene copolymer described further below) have relatively poor explosive decompression resistance and may be operable as a seal to temperatures down to about 0 degrees C. at atmospheric pressure, its Tg being higher at higher pressures such as encountered in operating environments. However, it does have relatively good chemical resistance, and good resistance to for example steam and amines.

By providing a seal, for example an O-ring seal, having a core of a low Tg and RGD resistant elastomeric material and an outer layer of a chemical resistant elastomer, then a seal can be provided having desirable properties in relation to:
chemical resistance
low temperature flexibility
resistance to rapid gas decompression

The seal may be an O-ring or similar seal, or another type of seal. While aspects of the invention have particular application in relation to O-ring seals, they are generally applicable to all seal types. Aspects of the invention may be applied to O-rings. Alternatively, the invention may be applied to other types of seal. SPRINGSELES (trade mark) and TEESELES (trade mark) both available from James Walker & Co Ltd, are two examples of seals which are generally used to seal higher pressures than O-rings.

Preferably the thickness of the outer layer is less than about 50%, preferably less than about 30% of the thickness of the seal. For example, the seal may comprise a 3.53 mm diameter core, the diameter of the seal being 5.33 mm including the outerlayer. An alternative seal may comprise a 5.33 mm diameter core being 6.99 mm in diameter including the outer layer.

Preferably the thickness of the layer on any particular region of the seal is less than about 30%, preferably less than 20% or less than about 10% of the thickness of the seal in that region.

The thickness of the layer is preferably sufficient to impart any necessary chemical resistance or other desired properties to the seal, without, if relevant, reducing the flexibility of the seal in an undesirable way. The formulation may include additives to modify the levels of permeability.

The core may also be coated with a thin metallic layer to reduce gas absorption before adding the outer layer. The metallic material could for example be a mixture of Cr and WC.

This feature is particularly advantageous in some examples and is provided separately. An aspect of the invention provides a seal comprising an inner core including core material, and an outer layer on the core comprising layer material, wherein the core includes an at least partial metallic surface layer. The metallic layer may include Cr and/or WC.

Also provided by the invention is a method of forming a seal comprising an inner core including core material and an outer layer comprising layer material, the method including the step of applying an at least partial coating of a metallic material onto a surface of the core and subsequently applying the layer material.

In example, the metallic layer around the core is flexible and preferably prevents or reduces ingress of fluids.

Preferably the outer layer comprises a fluoroelastomer or a perfluoroelastomer.

Alternatively or in addition, the outer layer may comprise HNBR or other elastomer with chemical resistance suitable for the relevant operating environment.

The layer preferably comprises a fluoroelastomer (FKM). The layer may comprise a perfluoroelastomer (FFKM). The layer may comprise one or more than one material. Preferably the fluorine content of the fluorinated-elastomer of the layer is greater than 60%, preferably greater than 64%, greater than 66%, preferably 68% or more.

Elastomers other than those including fluorine could be used.

The outer layer may include a tetrafluoroethylene propylene copolymer (TFE-P).

Examples of materials for use in the outer layer is AFLAS™ of Asahi Glass Co Ltd. Similar materials are available from DuPont as TBR grades and from Solvay as BR grades. Examples of HNBR polymers are made by Zeon and Lanxess (Bayer).

The outer layer may include a VITON fluoroelastomer or similar material from other manufacturers.

The outer layer may comprise a material including a copolymer or terpolymer of hexafluoropropylene (HFP), vinylidene fluoride (VDF or VF2) and tetrafluoroethylene (TFE). For example compounds based on VITON® ETP 600S can be used. Other polymer types, or equivalent polymers from other manufacturers may be equally suitable.

It is preferred that the outer layer material has good steam resistance, and/or good chemical resistance, for example good amine and hydrocarbon resistance.

In some cases it will be preferred for the outer layer to cover the whole of the exterior surface of the core. For example, where the outer layer provides chemical resistance of the seal, the outer layer preferably covers all parts of the core which might come into contact with the relevant harsh chemical environment. However, in other applications, a complete coverage will not be required. For example, the layer might be provided on only one surface of the core and/or in certain regions of the core, depending on the application.

The layer may comprise a single material, or more than one material. The outer layer may itself comprise more than one layer, or may comprise regions of different composition. Further layers or other regions of material may be provided between the outer layer and the core, and/or on an exterior surface of the outer layer. For example, a metallised coating may be provided on the core, for example to reduce permeation. The outer layer material may itself have good resistance to explosive decompression.

Preferably any coating or layer has an appropriate flexibility.

According to a further aspect of the invention there is provided a seal comprising: an inner portion including
silicone and/or a silicone-containing material, and/or
ethylene-propylene elastomer, for example EPM and/or EPDM, and/or
Fluorine containing elastomer, for example FKM or TFE-P, and/or
an RGD/ED resistant elastomer, and/or
an elastomer which is flexible at a temperature less than minus 10 degrees C.
an elastomer having the required low temperature properties for the intended application of the seal (preferably the elastomer has one or more of the features of the core described above)

And an outer layer on the inner portion, the outer layer comprising
a fluorine-containing elastomeric material, and/or
HNBR and/or
an elastomer having chemical resistance.

In some examples, a low-Tg material having good chemical resistance could be placed on the outside of an ED resistant core having a higher Tg. For example grades of FKM and/or HNBR having low Tg could be used at the outer layer. Such grades have good chemical resistance but may have unacceptable ED resistance properties for the given application. An ED resistant core would be used to give an acceptable overall performance through using the principle of two materials through the cross section.

In another example, acceptable seals may be provided which do not have good low temperature performance but are nevertheless desirable for some applications.

In an example, a terpolymer usable down to about minus 10 degrees C. might be used in combination with a core having good RGD/ED resistance, the terpolymer providing a chemically resistant outer layer. In such a case, low temperature performance might not be an important issue.

Preferably the seal has good steam resistance and/or good chemical resistance, for example to amines and hydrogen sulphide.

Preferably the core has high gas permeability and/or mechanical properties sufficient to give the required RGD resistance.

Preferably the core includes an elastomeric material.

Preferably the layer comprises an elastomeric material.

Preferably the layer has good steam resistance and good resistance to the presence of amines and hydrocarbons

The Tg of the material of the outer layer may be above minus 20 degrees C. In some examples, the Tg of the outer layer material will be below minus 20 degrees C.

The seal may comprise bonding material between the core and the outer layer.

For example, a layer of bonding agent may be provided to bond the outer layer to the core For example, Chemosil 5150 could be used, or a chemical treatment could be used, for example that described in EP 1025987.

The material of the bonding layer preferably includes material of the core and/or material of the outer layer.

In that way a strong and compatible bond can be achieved between the core and the outer layer.

Alternatively, with optimised processing conditions and compound formulations, the layer may be bonded directly to the core without a bonding layer being required.

A further aspect of the invention provides a seal comprising an inner core including core material, and an outer layer on the core comprising layer material, wherein:
the core material includes an elastomer and is capable of providing a sealing function above a first temperature
the layer material includes an elastomer and is capable of providing a sealing function above a second temperature,
   wherein the second temperature is lower than the first temperature.

In some applications, the temperature at which a sealing function can be achievable will be dictated by the material of the core and/or the layer. The temperature of sealing may also, or alternatively be affected by other factors, for example surface finish, level of squeeze, orientation of flashline and surface lubrication. For example, in any of the aspects described herein, the surface of the seal may be modified. For example, the surface of the material may be treated to modify one or more of its properties. In some examples, the surface is modified to change the coefficient of friction of at least a part of the surface of the seal. Such treatment may comprise for example a spraying technique, a plasma treatment for example to graft chemical groups onto a surface of the material to change its properties (for example Siloxane based groups), or other appropriate treatment. An example of a sprayed treatment is a water based resin based on PU and silicone from Whitford Corp. which is applied directly to the seals which are subsequently baked to harden the coating. In examples, the treatment is such that the surface of the material is energised. Alternatively or in addition to changing the friction coefficient, the treatment, for example addition of the chemical groups may change other properties of the material surface. In preferred examples, the reduction of the friction coefficient which is of principle importance. Of less interest are other properties of the seal, provided they do not compromise the material or the seal functionality. Preferably the treatment has an effect of lowering the coefficient of friction of at least a part of the material surface. Such lowering of the coefficient of friction can improve sealing performance where the surface-treated material is used in a seal. Without wishing to be bound by any particular theory, it is believed that a lower friction coefficient material at the surface of at least a part of the seal will allow the seal to energise more effectively. In known systems, grease or other applied lubricant is used to reduce the coefficient of friction at the surface of a seal. However, in time, such lubricant is found to be removed, for example by the action of the components of the system and/or movement of the seal arrangement. The use of grease or other component as a lubricant can also cause system contamination; there are some applications in which such components are not appropriate for use. There would be benefit in a seal having an inherent low coefficient of friction at least a part of the surface. Application of a friction-reducing coating on the seal housing in conjunction with the seal may in some examples improve performance still further. Thus a further aspect of the invention provides a seal having a friction-reducing coating on at least a part of an external surface, and a method for manufacture of such a seal.

Thus this feature is of particular advantage in some examples and is provided independently.

According to a further aspect of the invention, there is provided a seal comprising a material forming at least a part of the external surface of the seal, wherein the material at the external surface has been subject to a treatment to reduce its coefficient of friction. The treatment may be carried out to all or only a part of the material at the external surface.

According to a further aspect of the invention, there is provided a seal comprising an external surface including a material, wherein the material at a first part of the external surface has a lower coefficient of friction than the material at a second part of the external surface. Profiled seals may in some examples only require the lubricated or low coefficient of friction coating on the sealing surface.

The material at the first part of surface has preferably been subject to a treatment to reduce the coefficient of friction.

According to a further aspect of the invention, there is provided a method of making a seal, the method including the step of treating an external surface of the seal to reduce the coefficient of friction of at least a part of the surface.

The treatment may include applying a coating based on components including silicone, PU and fluorine to the surface.

The treatment may include modifying the composition of one or more components of the material at the surface. The treatment may include modifying the composition of an elastomeric material at the surface.

Components or groups may be inserted in the material at the surface during the treatment for example siloxane or fluorine-containing groups. As an example, a plasma technique may be used.

Preferably the seal has a TR10 less than −10 degrees C., preferably less than −30 degrees C., preferably less than −50 degrees C.

The reduction in the coefficient of friction may be at least 10%, preferably at least 20%. In examples, reduction in the coefficient of friction may be up to 50%, or even more. The coefficient of friction may be tested for example using an inclined plane test as known in the field.

In other aspects, as an alternative, or in addition, materials could be added to the elastomer compound of the seal itself to reduce the friction coefficient. Examples of such additions to the seal material include ‘controlled release’ additives such as oleamides and PTFE.

A further aspect of the invention provides a seal housing for a seal, the housing including an external surface, wherein at least a part of the surface includes material which has been subject to a treatment to reduce its coefficient of friction

Thus the seal and/or the seal housing may have a low coefficient of friction surface.

At least a part of the housing surface may include a coating. Such a coating preferably includes one or more materials having a relatively low coefficient of friction so as to reduce the coefficient of friction of the housing on which it is applied. The material of the coating may include PTFE.

A further aspect of the invention provide a seal assembly comprising a seal and a seal housing , wherein the seal and/or the housing has been treated to reduce the coefficient of friction of at least a part of its surface.

The treatment may include the application of a coating material.

In examples, the provision of a lubricated housing and/or seal surface can improve seal response, in particular at low temperatures.

In some preferred arrangements, both the seal and the housing are treated to reduce the coefficient of friction of at least a part of their external surface. The treatment of the seal may or may not be the same as the treatment of the housing.

In some cases the treatment will be the same, for example the application the same coating material to the substrate material. In other arrangements, different treatments could be used, which would give greater scope for optimisation of the treatment for each of the seal and housing.

There is benefit in “two phase” lubrication such as can be obtained when the seal and housing both have reduced coefficient of friction at at least a part of their surface. The two phase lubrication can lead to improved seal responsiveness, in particular when the seal assembly is pressurised at low temperatures.

An example of a suitable treatment for a seal for use with metal surfaces, for example on a seal housing, is a resin bonded PTFE coating, for example Armourcote (RTM of Surface Technology), or water-based coating such as DKAQW-3917 from ITW.

Preferably the ability of the seal to provide a sealing function is determined by measuring low temperature performance of the seal in the laboratory or test facility. It has been found in some cases that the actual sealing performance of a seal differs from the theoretical performance expected from consideration of the materials used, a seal (for example an O-ring seal) may have a sealing function at a temperature below what would be expected from its material properties.

In an example of a test for sealing performance at different temperatures, a test fixture housing three similar O-rings is used. The O-rings are mounted relative to an environmental chamber. For the test, the fixture is pressurised with nitrogen, and the leakage monitored via mass flow sensors. The results provide information as to whether the O-rings are providing a sufficient sealing performance.

Examples of two tests are as follows:

1. Pressure before cooling (PBC).

The O-rings are pressurised to (for example) 100 bar at ‘ambient’ temperature (above 10 degrees C.). The temperature is then reduced at a given rate, for example 0.3 degrees C./minute until one or more seals leak.

2. Pressure after cooling (PAC)

In this test, the test fixture is first stabilised at the test temperature before the pressure is applied. Once the temperature has stabilised, the fixture is pressurised (for example to 100 bar) and the presence of leakage through one or more O-rings is identified. The fixture is then returned to room temperature before next test is carried out to allow seals to ‘recover’. This second test is more representative of actual service conditions, though generally speaking leaks at higher temperatures than tests where the seal is allowed to ‘energise’ at room temperature (PBC).

Where reference is made herein to a seal having a particular sealing performance at a temperature, preferably the seal passes the first test, and/or the second test described. Preferably the material passes both tests. A further test is whether the sealing performance is in practice sufficient in the application to which the seal in question is to be put.

In some examples, the low temperature sealing performance for a given material may not be directly related to its Tg or TR10.

In examples of the invention, the following test can be carried out to see if the core material is capable of providing a sealing function above a first temperature which is lower than a second temperature above which the layer material is capable of providing a sealing function.

In the test, a first seal is produced including the core material but without the layer material, and the seal is tested at different temperatures to determine the lowest temperature at which the seal provides a sealing function. Then, a second seal including the layer material is subjected to the same tests to determine the lowest temperature at which the second seal provides the sealing function. A comparison of the temperatures determined in the first and second tests are compared.

In some cases, the variation of sealing performance with temperature of the core and layer materials will depend on the low temperature performance of the material from which the core and/or layer is made. For example the Tg and/or TR10 of the material will determine sealing performance.

A further aspect of the invention provides a seal comprising an inner core including core material, and an outer layer on the core comprising layer material, wherein the Tg and/or TR10 of the core material is greater than that of the layer material.

The Tg of the layer material is preferably less than the Tg of the core material in some examples.

The TR10 of the layer material is less than the TR10 of the core material in some examples.

The first temperature and/or the Tg of the core, and/or the TR10 of the core is preferably less than −20 degrees C., preferably less than −30 degrees C. in some examples.

The second temperature and/or the Tg of the layer, and/or the TR10 of the layer, is less than −40 degrees C., preferably less than -50 degrees C., preferably less than −60 degrees C. in some examples.

Preferably the seal meets the RGD acceptance criteria of the NORSOK M710 test (Annex B) and/or passes the Explosive Decompression test described herein.

Preferably the seal has one or more of the further features described in respect of one or more of the other aspects of the invention described herein.

The layer material is preferably chemically resistant. The core material is preferably chemically resistant. Conventionally, consideration is given as to whether the outer surface of a seal includes chemically resistant material. For example, a co-extruded seal might includes a chemically resistant material (for example an FKM or FFKM) only on the outside. In many applications, for example oil and gas applications, the seal is exposed to high pressures and long soak times, and this can lead to the contact media permeating into the outer surface and coming into contact with the core material. If the core material is one that is destroyed by the contact media, this can give rise in time to problems. By using core materials that are at least partially resistant to the contact media to cope with a level of permeation, would be desirable.

This important feature may be provided independently. Thus, a further aspect of the invention provides a seal comprising an inner core including core material and an outer layer on the core comprising layer material, wherein the core material includes an elastomer which is at least partially chemically resistant, and a layer material including an elastomer.

Preferably the chemical resistance has one or more of the further features described herein.

The core material may have a greater chemical resistance than the layer material.

In examples of the invention, the layer has a small thickness compared with the thickness of the core material. Therefore, in some applications, lesser chemical resistance of the layer material might be tolerated. For example if the layer material were to swell in the presence of particular media, then a larger % swelling of the layer might be acceptable compared with the same % swelling of the core material. For example, a % volume change of the layer material of 20% might be acceptable, compared with a % volume change of the core material where a change of 10% or preferably 5% less might be required.

The core material and/or the layer material may comprise hydrogenated acrylonitrile-butadiene, for example HNBR, or HNBR with a differing level of ACN.

The layer material may comprise a perfluoropolyether, for example Sifel® material or polyphosphazene, for example fluoroalkoxy-substituted polyphosphazene, or PNF®.

It is expected that in some applications, silicone and fluorosilicone will not have the required chemical resistance for use as the outer layer, but may be appropriate for use as a material for the core.

The core material may in some examples include any appropriate material, preferably an elastomer, for example one or more materials indicated herein.

In some examples the core material and/or the layer material comprises a nitrile butadiene rubber or a hydrogenated nitrile butadiene rubber. The hydrogenated nitrile butadiene rubber may have an acrylonitrile content of from, 20% to 60% or higher. In some examples, the acrylonitrile content is, for example up to 55% or 50%. In an example, the acrylonitrile content is about 51%. In some examples, the rubber may have an acrylonitrile content of between about 30% to 45%. Alternatively or in addition, the hydrogenated nitrile butadiene rubber has an acrylonitrile content of from 10% to 30%. Different arrangements can be used as appropriate. For example, a seal comprising an HNBR having a 25% nominal ACN content can be used as the core material, an outer layer material including HNBR having a 17% nominal ACN content (for example ELAST-O-LION (EOL) 985). In a further example, the seal material has a core including EOL101 core with nominal 36% ACN content. The relatively lower ACN content of less than 30% or 20% in the core gives a compromise of better low temperature flexibility/mechanicals, and in some examples it may be possible for the composite to form an acceptable seal at −46 degrees C. or below. In examples where the core has a higher content of ACN, for example EOL101, the lowest acceptable sealing temperature may be higher, for example −40 degrees C.).

This feature is of particular interest and a further aspect of the invention provides a seal comprising an inner core including core material, and an outer layer on the core comprising layer material, wherein:
the core material includes an NBR or HNBR material having an acrylonitrile content of less than 30%, preferably 25% or less,
the layer material includes an NBR or HNBR material having an acrylonitrile content less than that of the core material.

In examples, the low-content ACN HNBR may be provided as the layer material and higher-content ACN HNBR may be provided as the core material.

The hydrogenated nitrile butadiene rubber may be formed by hydrogenating at least 90% of the double bonds present in the parent nitrile butadiene rubber.

The hydrogenated nitrile butadiene rubber may be formed by hydrogenating at least 98% of the double bonds present in the parent nitrile butadiene rubber.

The core material and/or the layer material may comprise a silicone cross-linked perfluoropolyether. The silicone cross-linked perfluoropolyether may comprise a poly(perfluoroalkylene oxide) backbone. The silicone cross-linked perfluoropolyether may comprise a poly(perfluoropropylene oxide) backbone.

The silicone cross-linked perfluoropolyether may be selected from SIFEL® elastomers available from Shin-Etsu Chemical Co. Preferably the grade selected is in the form of a gum (rather than for example a liquid).

The core material and/or the layer material may comprise a polyphosphazene polymer. The polyphosphazene polymer (PNF, RTM Materials Science Technology) may comprise a repeating unit having the formula —[P(R¹)(R²)═N]— wherein each R¹ and each R² is independently an inorganic moiety or an organic moiety. Each R¹ and each R² may be independently selected from —O—(C₁-C₆)alkyl, —O—(C₆-C₁₀)aryl, —O—(C₁-C₆)alkyl(C₆-C₁₀)aryl, —NH—(C₁-C₆)alkyl, —NH—(C₆-C₁₀)aryl and —NH—(C₁-C₆)alkyl(C₆-C₁₀)aryl, wherein said alkyl and aryl groups are optionally substituted by one or more fluorine atoms.

Each R¹ and each R² may be independently selected from —OCH₃, —OCH₂CH₃, —OCF₃, —OCF₂CF₃, —OCH₂CF₃, —OC₆H₅, —OC₆F₅, —NHCH₃, —NHCH₂CH₃, —NHCF₃, —NHCF₂CF₃, —NHCH₂CF₃, —NHC₆H₅, and —NHC₆F₅.

Each R¹ and each R² may be independently selected from —OCH₃, —OCH₂CH₃, —OCF₃, —OCF₂CF₃, —OCH₂CF₃, —OC₆H₅, and —OC₆F₅.

Other compositions based on the polyphosphazene polymer may be used.

For the desired chemical resistance, it is preferred for the core material and/or the layer material to include a fluorine-containing polymer.

The fluorine-containing polymer may include a fluorine-containing elastomer and/or a fluorine-containing silicone material.

A further aspect of the invention provides a seal comprising an inner core including core material, and an outer layer on the core comprising layer material, wherein core material and/or the layer material includes one or more of hydrogenated nitrile butadiene rubber, silicone cross-linked perfluoropolyether, polyphosphazene polymer,

and wherein the TR10 of the outer layer and/or the core is less than −30 degrees C., preferably less than −40 degrees C., less than −50 degrees C., less than −60 degrees C. or less than −70 degrees C.

A key mechanism of failure in RGD is crack initiation and propagation. There would be benefit in providing a seal comprising a material that resisted crack propagation.

Preferably the core material includes the core includes an element for resisting crack propagation in the core material.

According to a further aspect of the invention there is provided a seal comprising a core including core material and an outer layer on the core comprising layer material, wherein the core includes an elastomeric material including elements for resisting crack propagation in the core material.

In preferred examples, the material includes domains, either randomly distributed or for example co-extruded through the product cross-section, which are capable of absorbing energy and preferably reducing or stopping crack propagation. Such features find particular application in relation to thicker sections of material, for example greater than 5 mm, or 7 mm or more.

Any appropriate elements may be provided. More than one type of element may be provided. The elements might be provided throughout the core, or only in a particular region or areas of the core.

The elements for resisting crack propagation may include a plurality of domains of elastomeric material.

An element may include a boundary between two layers of elastomeric material.

For example the core material may comprise a broken or continuous layer or layers. The presence of such layer or layers of elastomer may assist in resisting crack growth in the core material.

The layers may comprise the same elastomeric material.

Alternatively, more than one elastomeric material, or mix of materials, are possible.

The layers may be formed by co-extruding the layers.

An element may include a region of uncured, or partially cured material.

For example, the core material may include uncured domains. Part or all of the elastomeric material of the core may comprise intermingled regions of vulcanised and of unvulcanized or partially vulcanized portions. This may be carried out for example by subjecting uncured elastomer to highly selective vulcanisation such as described in UK Patent Application No. 2276625.

An element may comprise an inclusion in the elastomer.

The inclusion may comprise a particulate or other element of another material.

The element may comprise a plurality of particles or grains in the elastomer.

Thus the core material may be formed of a composite material, in which the matrix is provided by one or more elastomeric materials, and elements, for example particles, rods, granules, fibres, or other elements are included in the matrix to reduce crack propagation.

The particles may include for example vulcanised elastomer granules for example with a low cure state and/or high hysteresis. Such particles may be randomly distributed or distributed regularly and may be of similar or varied particle size, for example from 4 microns or larger. Portions of the energy absorbing material could be strategically placed in the product to provide reduced crack propagation at particular areas. For example, one or more portions could be located in thicker portions of the product, or an area more vulnerable to cracking.

The core may comprise a composite material including a matrix of an elastomeric material, and a plurality of elements distributed in the matrix.

The ‘energy absorbing’ elements could, for example, be co-extruded or fabricated through the cross-section for example either as concentric rings, or ‘rods’ along the length of the product.

Features of this aspect of the invention may be provided in combination with features of other aspects of the invention, as appropriate.

The layer material may include a material having a Tg lower than that of the core material.

A further aspect of the invention provides a method of manufacturing a seal as described herein.

A further aspect of the invention provides a method of manufacturing a seal comprising forming a core comprising a core material, and forming an outer layer on the core, the outer layer comprising outer layer material.

The core may comprise freely cured extrudate, or could comprise uncured material which is cured, optionally together with other layers, during the moulding process.

The method may comprise co-extruding the core material and the outer layer material.

The method may comprise including providing a bonding layer between the core and the outer layer, the bonding layer comprising bonding material.

The bonding material may comprise core material and/or outer layer material, preferably a blend of the core material and the outer layer material.

The method may comprise the steps of: forming the core; applying the bonding material to the core; and moulding the core and outer layer to form the seal.

The core material may be cured or uncured before the bonding material is applied.

The bonding material may be applied by painting or spreading.

The bonding material may be dissolved in a suitable solvent before application.

The method may comprise co-extruding the core material, bonding material and outer layer material.

The core material and outer layer material can be blended together to form the bonding material before vulcanisation.

The outer layer may be formed by stamping out the material, by extrusion as indicated above, whether as a co-extrusion (double or triple) or by any other method. It is preferred that the outer layer material has excellent chemical resistance. It is preferred for the outer layer material to have good explosive decompression resistance.

A surface finishing may be carried out on a surface of the seal.

The seal may comprise an O-ring seal. The “seal” referred to herein may be a part or an element of a seal.

According to examples of the invention, there can be provided an improved seal having improved chemical resistance with low temperature flexibility and sealability.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying drawing, in which:

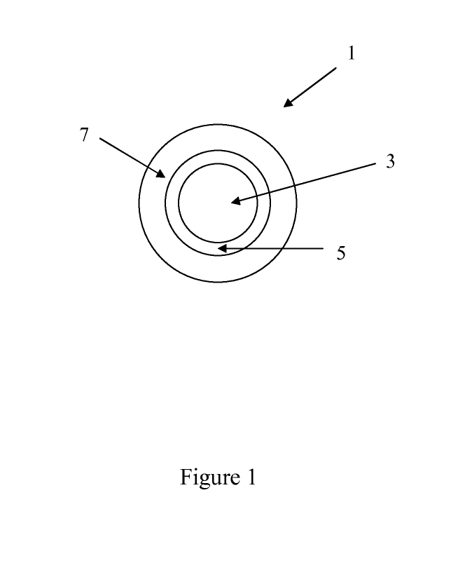

FIG. 1 shows schematically a section through an O-ring seal of an example of the invention.

FIG. 1 shows schematically a transverse section through a part of an O-ring seal 1. The seal has a generally circular cross section. The seal material comprises a core 3 of generally circular cross section and two layers: a first bonding layer 5, and an outer layer 7.

Generally, the inner core 3 comprises a material having good low temperature flexibility and/or good resistance to explosive decompression. In this example, the core 3 comprises silicone rubber. As described above, other materials could be used as the core material.

The outer layer 7 comprises a material having a good chemical resistance. For example, the layer 7 may comprise AFLAS™ or VITON™ ETP-600S, VPL 85540 (FKM from Solvay with TR10 of approx −40C) FFKM or HNBR.

The bonding layer 5 is optional.

The thickness of the layers has been exaggerated in FIG. 1 for clarity. In an example, the diameter of the O-ring section may be 6.99 mm, the silicone core diameter being 5.33 mm.

Various different methods can be used to manufacture the O-ring.

The core material, bonding layer material and the outer layer material may be co-extruded to form the seal.

The bonding layer material may comprise a blend of the outer layer compound and the core compound which are blended together before vulcanisation. This will allow the layers to bond together during the moulding process.

Alternatively, the core 3 may be formed and the bonding material may be spread or painted on to the core. The bonding material may comprise a blend of the outer layer material and core material blended before vulcanisation and dissolved in a suitable solvent before being applied to the core. The core may be cured or uncured, the bonding material is applied to the core and dried. This will allow the inner core and the outer layer to bond together during a subsequent moulding process.

The product could also be vulcanized in a free state after extrusion, for example in an inert atmosphere such as nitrogen rather than moulding.

Alternatively, the bonding material may comprise a different bonding agent, for example Chemosil 5150. Alternatively a chemical treatment could be used, for example as described in EP1025987.

In some cases, it may be possible to bond the outer layer to the core without bonding material being used. In this case, the bonding layer 5 may not be present in the O-ring. In the following examples, a material of relatively low Tg is provided on the surface of a core including material of a relatively higher Tg. Having reference to FIG. 1, where the materials are used in an O-ring seal, the material of relatively low Tg is provided at the outer layer 7, and the material of relatively higher Tg is provided at the core 3. It will be appreciated that the material combinations may find application beyond o-ring seals.

### EXAMPLE 1

The core comprises a ‘medium’ ACN (acrylonitrile) HNBR (hydrogenated nitrile butadiene rubber), for example including 30% or more by weight of ACN. Such material has good mechanical properties and RGD resistance.

An outer layer 7 includes low ACN HNBR, for example including 25% or less of ACN, for example 20%. Such material has good low temperature performance and approximately equal chemical resistance to the core. It does however lack the mechanical properties of the core material.

For example the core may comprise ELAST-O-LION 101® of James Walker Group having a TR10 of −17C, and the outer layer may comprise ELAST-O-LION 985® of James Walker Group having a TR10 of −37C.

Because the core material and the layer material are compatible with each other, both comprising ACN HNBR, they may be formed by co-extrusion and subsequent moulding. Alternatively, premoulded cores may be overmoulded with the outer layer. The products could also be fabricated from uncured sheet and extrusion prior to moulding.

In an example, the thickness of the layer is between about 5% and 25% of the section of the product each side of the core.

The seal formed has a good RGD resistance, chemical resistance typical for an HNBR, and provides good low temperature sealing.

### EXAMPLE 2

The core comprises an FKM core material which is optimized for RGD resistance This could be based on a dipolymer or terpolymer with TR10 values of −18C and −12C respectively. For example an FKM terpolymer could be used as the core material.

The outer layer comprises an FKM material, for example Viton GLT or GFLT which is flexible at low temperature and which has a TR10 of about −30C and −29C respectively. The cost of the material of this layer is considerably greater than the cost of the material of the core.

A bonding layer may be applied between the core and the outer layer material to form the seal. However, in some examples such a bonding layer may not be required. For example if both the core material and outer material are peroxide-cured materials, a bonding layer may not be necessary (although such a layer could still be used, as desired).

The seal formed has a good RGD resistance, good chemical resistance and provides good low temperature sealing.

### EXAMPLE 3

The core comprises an FKM elastomer which is flexible at low temperature, for example below −30 degrees C.

The outer layer includes a fluorinated silicone material, for example a perfluoropolyether/silicone material, for example SIFEL available from Shin-Etsu Chemical Co Ltd, Japan. This outer layer material has flexibility at temperatures as low as −60 degrees C. SIFEL 9700 grade may be used.

In this example a bonding layer is advantageously applied between the core and the outer layer material to form the seal. The seal formed has a good RGD resistance, good chemical resistance and provides very good low temperature sealing at temperatures as low as −60 degrees C.

This outer layer material may also be used with different core materials.

### EXAMPLE 4

PNF, (a fluoroalkoxy-substituted polyphosphazene) of Materials Science Technology Inc, Houston, US is provided as the layer material. PNF has low temperature flexibility at −70 degrees C.

The core may comprise for example an FKM material having RGD resistance.

A bonding layer may be applied between the core and the outer layer material to form the seal.

The seal formed has a good RGD resistance, good chemical resistance and provides very good low temperature sealing at temperatures as low as −70 degrees C.

In each of these examples, the core material contributes RGD resistance and overall good mechanical properties. The mechanical properties of the layer may be inferior to those of the core. For example, the mechanical properties, for example stiffness, of the SIFEL and PNF material layers is relatively poor and the seal relies on the presence of the core material supporting the layer material Furthermore, many of the layer materials indicated above are expensive, and so the use of the core allows a thinner layer of the more expensive material to be used.

### EXAMPLE 5

The core includes silicone having a gas transmission rate of about 1800 cc/m2/hr under 5 bar N2 at 20C such as S2475 from Dow Corning Ltd.

The coating layer includes SIFEL, for example 9700 grade (in the form of a gum). In some examples described herein the grades which are in the form of a gum are preferable to liquid grades.

The resulting seal is highly resistant to RGD, and also has good low temperature sealing ability.

The examples described are not restricted to O-ring seals, but can be used as appropriate for any elastomer product. The product may include other elements or components, for example plastic or metallic anti-extrusion elements.

As indicated above, the product may further include energy-absorbing elements, for example to reduce or prevent crack propagation in the material. For example, randomly or strategically placed particulates or lengthwise profiles through the product cross section with a high hysteresis, can absorb energy and inhibit crack propagation.

### James Walker Explosive Decompression Test Procedures

The following parameters are used to test an O-ring seal.

Temperature: 100 degrees C.

Pressure: 138 bar

Media: methane, carbon dioxide mixture

Seal Size: SAE AS 568-329 (or other)

Groove fill: 83% (nominal)

Compression: 14% (nominal)

The general procedure is as follows:
i. Heat rig to test temperature
ii. Apply test pressure
iii. Soak seals at temperature and pressure for a minimum of 72 hours
iv. Decompress instantaneously
v. Repressurise; soak at temperature and pressure for 1.5 hours
vi. Decompress instantaneously
vii. Repeat steps iv and v 18 further times with a minimum of 1 hour soaking (ie 20 decompressions in total) over a four day period, monitoring pressure/leakage throughout
viii. After final cycle, purge with nitrogen to evacuate remaining gas mixture
ix. Soak seals at test temperature in nitrogen for 24 hours

Assessment:

Pressure/leakage is monitored continuously throughout testing via pressure gauges and OVA/sonic leak detection. Each of eight seals tested is visually examined externally and, additionally, cut into four sections where the following criteria are applied:

0=no internal cracks, holes or blisters of any size

1=fewer than four internal cracks, each shorter than 50% of the cross section, with a total crack length of less than the cross section

2=fewer than four internal cracks, each shorter than 50% of the cross section, with a total crack length of less than 2.5 times the cross section

3=fewer than nine internal cracks, of which a maximum of two cracks can have a length between 50% and 80% of the cross section

4=more than eight cracks; or one or more cracks longer than 80% of the cross section

5=one or more cracks through the cross section or complete separation of the seal into fragments

A seal assessed at 4 or 5 is deemed to be unacceptable Therefore, to pass the test, the seals have ratings no higher than a 3 in any of the four cut seal segments. An example would be 0, 1, 3, 2 (pass). 0, 1, 3, 4 would be a ‘fail’ for a particular seal because of the one rating of 4.

It will be understood that the present invention has been described above purely by way of example, and modification of detail can be made within the scope of the invention.

Each feature disclosed in the description, and (where appropriate) the claims and drawings may be provided independently or in any appropriate combination.

1-114. (canceled)

115. A seal comprising a core including core material and an outer layer on the core comprising layer material, wherein the core includes an elastomeric material including elements for resisting crack propagation in the core material.

116. A seal according to claim 115, wherein the elements for resisting crack propagation include a plurality of domains of elastomeric material.

117. A seal according to claim 115, wherein an element includes a boundary between two layers of elastomeric material.

118. A seal according to claim 117, wherein the layers comprise the same elastomeric material.

119. A seal according to claim 117, wherein the layers are formed by co-extruding the layers.

120. A seal according to claim 115, wherein an element includes a region of uncured, or partially cured material.

121. A seal according to claim 115, wherein an element includes an energy absorbing layer or layers through the cross-section of the seal.

122. A seal according to claim 115, wherein an element includes an inclusion in the elastomer.

123. A seal according to claim 122, wherein the element comprises a plurality of particles in the elastomer.

124. A seal according to claim 115, wherein the core comprises a composite material including a matrix of an elastomeric material, and a plurality of elements distributed in the matrix.

125. A seal according to claim 115, wherein the layer material includes a material having a Tg lower than that of the core material.

126. A seal according to claim 115, further comprising bonding material between the core and the outer layer.

127. A seal according to claim 126, wherein material of the bonding layer includes material of the core and/or material of the outer layer.

128. A method of manufacturing a seal according to claim 115, comprising forming a core comprising a core material, and forming an outer layer on the core, the outer layer comprising outer layer material.

129. A method according to claim 128, including co-extruding a plurality of layers of elastomeric material to form the core, having a plurality of boundaries between the layers.
